(19) United States
(12) Patent Application Publication
(10) Pub. No.: US 2010/0255698 A1
(43) Pub. Date: Oct. 7, 2010

(54) ELECTRONIC DEVICE AND CONNECTOR THEREOF

(75) Inventor: Chien-Hsiung CHEN, Taipei City (TW)

Correspondence Address: Muncy, Geissler, Olds & Lowe, PLLC, 4000 Legato Road, Suite 310, FAIRFAX, VA, 22033, US

(73) Assignee: COMPAL ELECTRONICS, INC.

(21) Appl. No.: 12/546,330

(22) Filed: Aug. 24, 2009

(30) Foreign Application Priority Data
Apr. 3, 2009 (TW) 98111223

(51) Int. Cl. H01R 13/62

(52) U.S. Cl. 439/152

(57) ABSTRACT

An electronic device includes a housing and a connector. The connector is disposed in the housing to allow an external connection plug to be connected thereto. The connector includes an electromagnetic switch module and a sensing module. The electromagnetic switch module includes a first switch to activate the electromagnetic switch to produce an electromagnetic force. The sensing module includes a sensing element. The sensing element is positioned to be moved by the electromagnetic force when the electromagnetic switch module is activated thereby separating the external connection plug from the connection port.

### RELATED APPLICATIONS

This application claims priority to Taiwan Application Serial Number 98111223, filed Apr. 3, 2009, which is herein incorporated by reference.

### BACKGROUND

1. Technical Field

The present disclosure relates to an electronic device. More particularly, the present disclosure relates to an electronic device having a connector.

2. Description of Related Art

Due to rapid development in information technology, applications on electronic devices have become more complex and are able to do more things. Therefore electronic devices such as notebooks, personal digital assistants etc. have been frequently used in our daily life to provide increased convenience and efficiency.

Generally speaking, when operating an electronic device such as a notebook, the user usually places the notebook on a desk and connects the notebook to a power cable (that connects to a main power source), a mouse plug, an earphone and other external connecting plugs in accordance with the user's requirements and specific needs.

However, when the user wants to move the notebook to another place, all the external devices connected to the plugs and sockets on the notebook have to be disconnected from the notebook. Furthermore, when separating the external devices from the notebook manually, it takes much time and easily produces non-axial forces that can damage the electronic device.

Consequently, it is apparent that we need a connector, which is able to have external connecting plugs separated from the connecting ports of the electronic device automatically, so as to decide whether or not these external connecting plugs are to be separated.

### SUMMARY

According to one embodiment of the present invention, a connector is used for an electronic device. The connector includes an electromagnetic switch module and a sensing module. The electromagnetic switch module includes a first switch to activate the electromagnetic switch module to produce an electromagnetic force. The sensing module includes a sensing element and a connection port connected to the sensing element to allow an external connection plug to be connected thereto. The sensing element is positioned to be moved by the electromagnetic force when the electromagnetic switch module is activated thereby separating the external connection plug from the connection port.

According to another embodiment of the present invention, an electronic device includes a housing and a connector. The connector is disposed in the housing to allow an external connection plug to be connected thereto. The connector includes an electromagnetic switch module and a sensing module. The electromagnetic switch module includes a first switch to activate the electromagnetic switch to produce an electromagnetic force. The sensing module includes a sensing element and a connection port connected to the sensing element to allow the external connection plug to be connected thereto. The sensing element is positioned to be moved by the electromagnetic force when the electromagnetic switch module is activated thereby separating the external connection plug from the connection port.

### BRIEF DESCRIPTION OF THE DRAWINGS

FIG. 1 is a three-dimensional drawing of an electronic device according to the first embodiment of the present invention.

FIG. 2 is a cross-sectional view taken along line 2-2 of FIG. 1.

FIG. 3a is a cross-sectional view taken along line 3-3 of FIG. 1, depicting the electronic device placed on a plane.

FIG. 3b is a cross-sectional view taken along line 3-3 of FIG. 1, depicting the electronic device removed from the plane.

FIG. 4 is a circuit diagram of the electronic device of FIG. 1.

FIG. 5 is a three-dimensional drawing of an electronic device according to the second embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

In one aspect, one embodiment of the present invention provides an electronic device, wherein an external connection plug can be separated from the connection port of the electronic device automatically or manually, i.e. the user can decide whether or not the connection plug is to be separated.

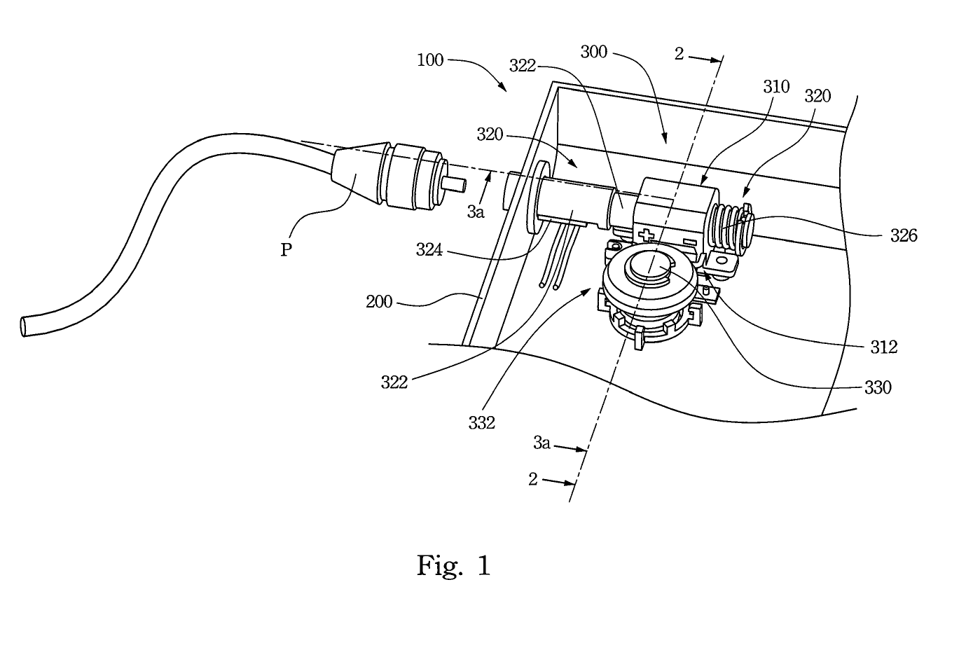

FIG. 1 is a three-dimensional drawing of an electronic device according to the first embodiment of the present invention. The electronic device 100 includes a housing 200 and a connector 300. The connector 300 includes an electromagnetic switch module 310 and a sensing module 320. The electromagnetic switch module 310 includes a first switch 312. The first switch 312 activates the electromagnetic switch module 310 to produce an electromagnetic force. The sensing module 320 includes a sensing element 322 and a connection port 324 connected to the sensing element 322. The connection port 324 allows an external connection plug P to be connected. The electromagnetic force may induce the displacement of the sensing element 322 so as to separate the external connection plug P from the connection port 324.

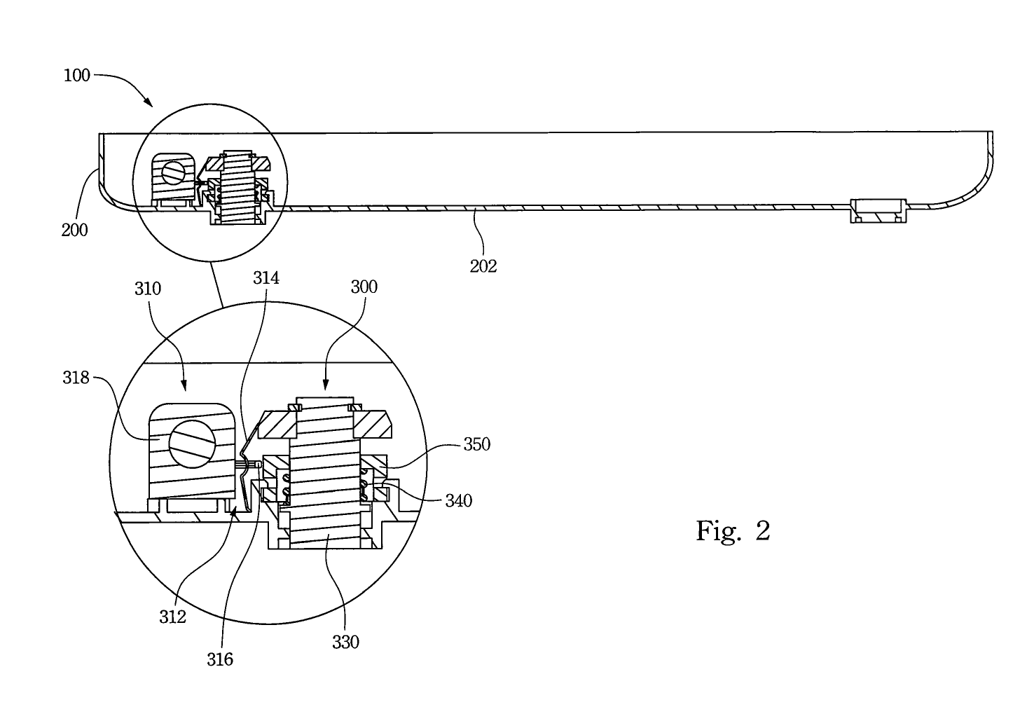

Refer to FIG. 2. The connector 300 includes a linkage element 330, a first restoring element 340 and a limiting frame 350. The linkage element 330 passes through a bottom surface 202 of the housing 200. In accordance with the first embodiment, the linkage element 330 can also be disposed at one foot piece of the electronic device 100. Furthermore, the linkage element 330 cooperates with the first switch 312 of the electromagnetic switch module 310, and the first restoring element 340 is disposed between the limiting frame 350 and the housing 200.

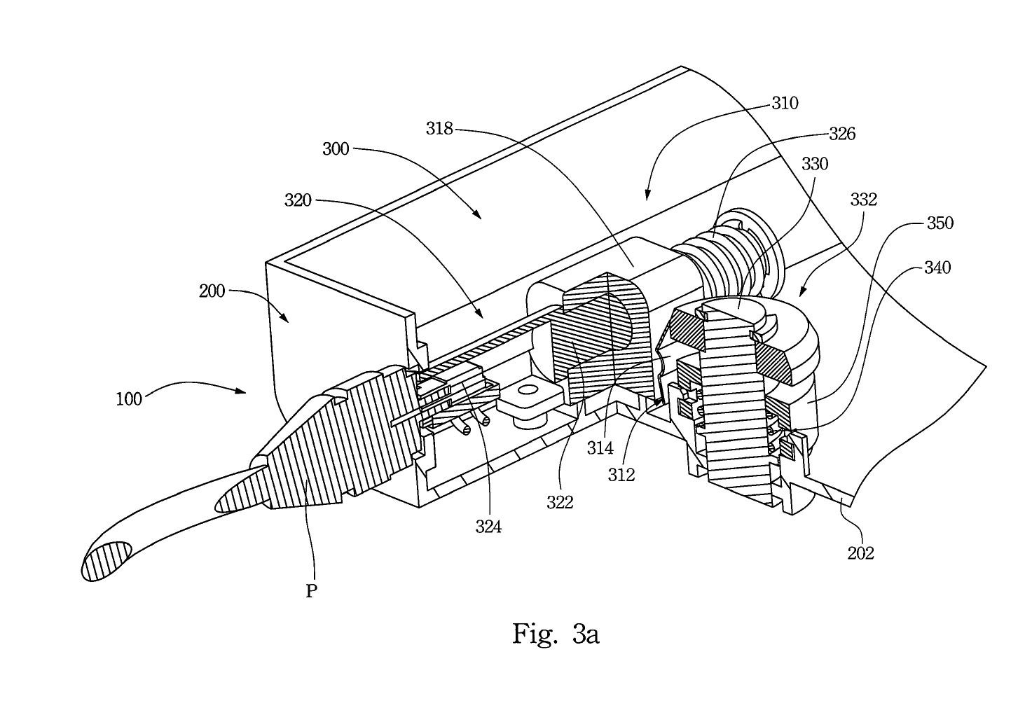

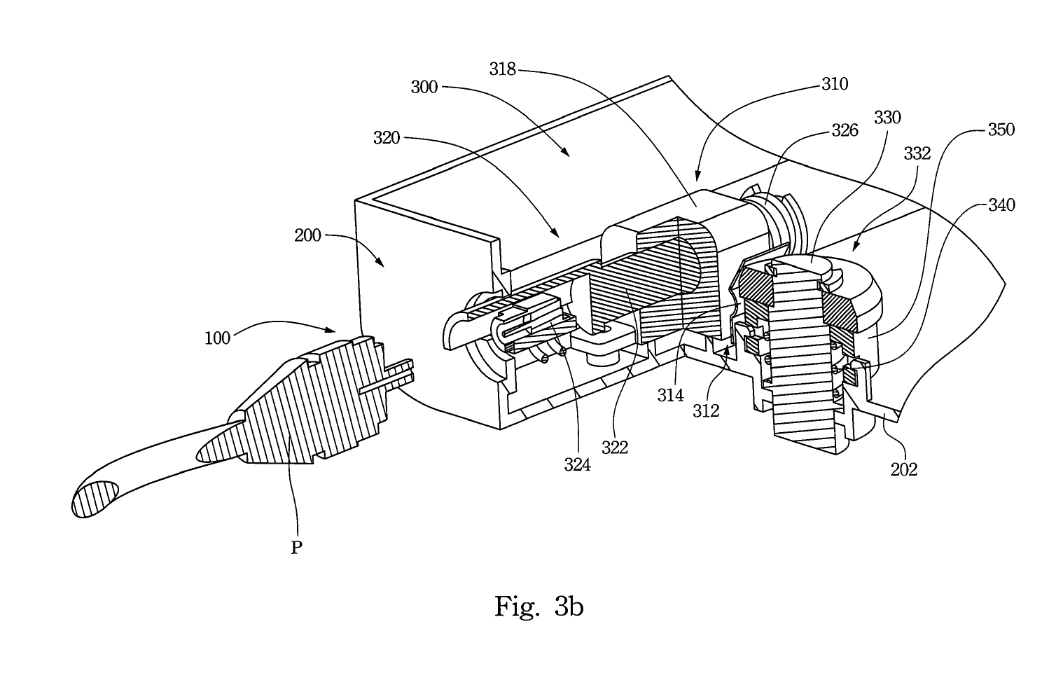

Refer to FIG. 3a. The first switch 312 is turned off when the linkage element 330 is at a first position. As shown in FIG. 3b, the first switch 312 is turned on when the linkage element 330 is at a second position. Furthermore, the first restoring element 340 is spring housed in an end portion of the linkage element 330, and the elastic force of the first restoring element 340 forces the linkage element 330 towards the second position.

Concretely speaking, when the user places the electronic device 100 onto a plane, the reaction force between the electronic device 100 and the desk forces the linkage element 330 towards the first position, so that the first switch 312 is in off mode. Meanwhile the first restoring element 340 is also compressed due to the limitation of the linkage element 330 and limiting frame 350. When the electronic device 100 is removed from the plane, the reactive force is no longer applied to the linkage element 330. As there is no compression limitation to the first restoring element 340, the elastic forces shifts is the linkage element 330 to the second position. Additionally, besides being a spring, the first restoring element 340 could be a rubber or an elastic plate as well.

FIG. 2 is a cross-sectional view taken along line 2-2 of the connector 300 in FIG. 1. The electromagnetic switch module 310 includes a leaf spring 314, a power junction 316 and a solenoid 318. The power junction 316 is electrically connected to the solenoid 318. Accordingly, when the leaf spring 314 is in contact with the power junction 316, the first switch 312 is turned on so as to charge the solenoid 318 for the electromagnetic induction.

As shown in FIG. 3a, when the electronic device 100 is placed onto the plane, the linkage element 330 is at the first position. Meanwhile, a push element 332 of the linkage element 330 has the leaf spring 314 move away from the power junction 316, and therefore the first switch 312 is in an off position. As shown in FIG. 3b, when the electronic device 100 is taken away from the plane, the linkage element 330 is at the second position. Meanwhile, the push element 332 of the linkage element 330 is not in contact with the leaf spring 314. Accordingly, the leaf spring 314 may be reset to be in electrical contact with the power junction 316 so as to turn on the first switch 312.

In the present embodiment, the structural cooperation between the leaf spring 314 and the linkage element 330 is changeable. For instance, when the linkage element is at the first position, the push element of the linkage element may not touch the leaf spring, thereby causing the leaf spring to move away from the power junction, i.e. the first switch is in the off position. When the linkage element is at the second position, the push element of linkage element pushes the leaf spring so that the leaf spring may touch the power junction, thereby turning on the first switch.

The sensing module 320 includes a second restoring element 326 connected to one end portion the sensing element 322 facing away from the connection port 324, and the direction of the elastic force of the second restoring element 326 is inverse to that of the movement of the sensing element 322 induced by the electromagnetic force. Accordingly, when the first switch 312 is turned on, the solenoid 318 is charged for the electromagnetic induction and produces the electromagnetic force in order to have the sensing element 322 move forwards so that the second restoring element 326 may be stretched. When the electromagnetic switch module 310 is not activated, the second restoring element 326 will elastically force the sensing element 322 to return. Moreover, not only could the second restoring element 326 be a spring, but also a rubber or an elastic plate.

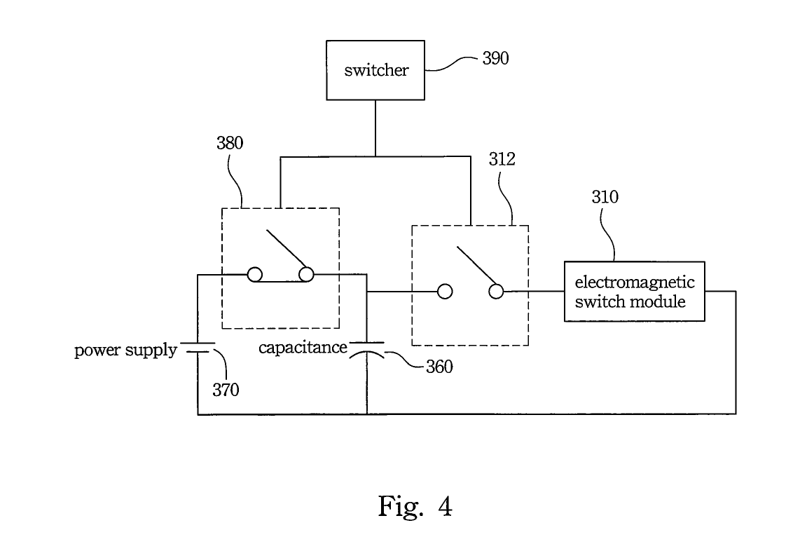

FIG. 4 is a circuit diagram of the electronic device of FIG. 1. The connector 300 includes a capacitor 360 electrically connected to the first switch 312. When the electronic device 100 is removed from the plane, the first switch 312 is in the on position and has the capacitor discharge through the electromagnetic switch module 310 so as to produce the electromagnetic force. Therefore, the electromagnetic force induces a displacement of the sensing element 322 in order that the connection plug P may be separated from the connection port 324. When the capacitor 360 finishes discharging, the sensing element 322 can return immediately due to the tension of the second restoring element 326.

Moreover, the connector 300 includes a power supply 370, a second switch 380 and a switcher 390. The second switch 380 is electrically connected to both of the power supply 370 and the capacitor 360. When the first switch 312 is in the on position, the switcher 390 turns on the second switch 380, and when the first switch 312 is in the off position, the switcher 390 turns off the second switch 380.

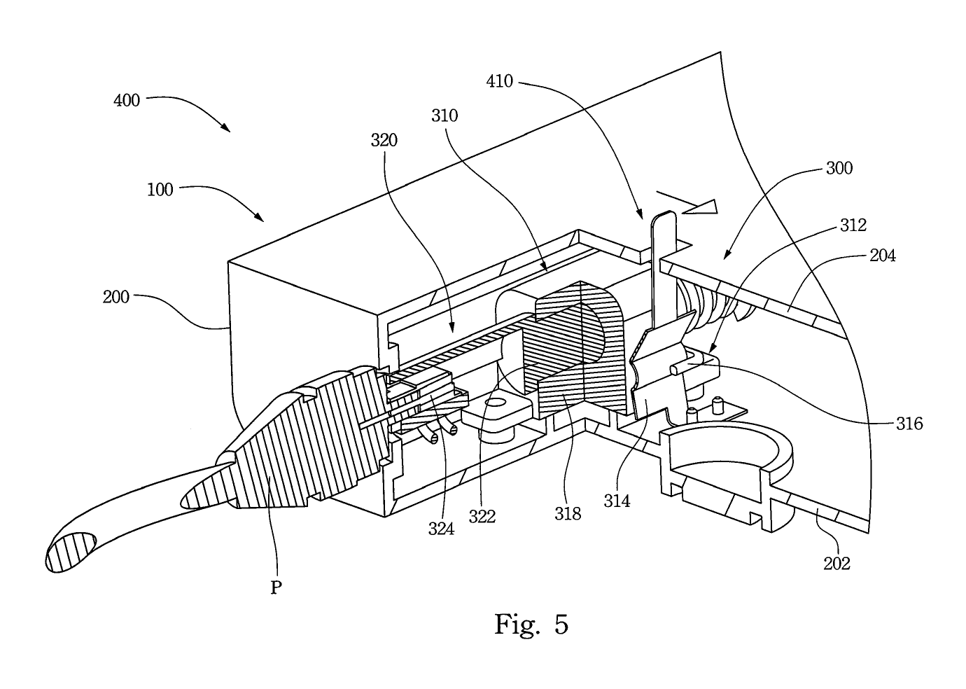

Accordingly, when the electronic device 100 is placed onto the plane, the first switch 312 is turned off and therefore the switcher 390 turns on the second switch 380, so that the power supply 370 may charge the capacitor 360. When the electronic device 100 is removed from the plane, the first switch 312 is activated and therefore the switcher 390 switches off the second switch 380, so that the capacitor may discharge through the solenoid 318. FIG. 5 is a partial three-dimensional drawing of the electronic device 400 of the second embodiment. The electronic device 400 includes a housing 200 and a connector 300 disposed in the housing. The connector 300 has an electromagnetic switch module 310 and a sensing module 320. The electromagnetic switch module 310 includes a first switch 312. The first switch 312 activates the electromagnetic switch module 310 to produce an electromagnetic force. The sensing module 320 includes a sensing element 322 whose terminal is connection port 324. An external connection plug P passing through the connection port 324, and the electromagnetic induction of the electromagnetic switch module 310 causes a displacement of the sensing element 322 so that the connection plug P may be separated from the connection port 324.

Reference is made to FIG. 5, the difference between the present embodiment and the embodiment described above is that: One end portion of the linkage element 410 of the connector 300 is disposed on the top surface of the housing 200 of the electronic device 100, and the other end portion is connected to a leaf spring 314 of the electromagnetic switch module 310. The terminal of the linkage element 410 can also be disposed on the side surface of the housing 200 in accordance with the actual demand.

It is apparent that the user can remove the linkage element 410 from the first position to the second position through the top surface 204 of the housing 200, and the elastic force of the leaf spring 314 can also reset the linkage element 410. Accordingly, the user can remove the linkage element 410 manually in order to decide whether the connection plug P is to be separated from the electronic device 100. In another aspect, the embodiment of present invention provides a connector. The connector causes the electromagnetic induction in accordance with the operation mode of the electronic device so that the connection plug may be separated from the connection port of the electronic device automatically. Furthermore, the user can also enforce the separation between the connection plug and the connection port in accordance with the actual demand. As the disclosures of the connection and the operation of the connector device have been described in the embodiment above, it is unnecessary to discuss here again.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A connector for an electronic device, the connector comprising:
an electromagnetic switch module comprising a first switch to activate the electromagnetic switch module to produce an electromagnetic force; and
a sensing module comprising a sensing element and a connection port connected to the sensing element to allow an external connection plug to be connected thereto, wherein the sensing element is positioned to be moved by the electromagnetic force when the electromagnetic switch module is activated thereby separating the external connection plug from the connection port.

2. The connector of claim 1, further comprising:
a linkage element passing through a housing of the electronic device and cooperating with the first switch of the electromagnetic switch module, wherein the linkage element is operative to move between a first position and a second position, the first switch is turned off when the linkage element is at the first position, and the first switch is turned on when the linkage element is at the second position; and
a first restoring element connected to the linkage element for elastically forcing the linkage element toward the second position.

3. The connector of claim 2, further comprising:
a limiting frame, wherein the first restoring element is disposed between the limiting frame and the housing of the electronic device.

4. The connector of claim 2, wherein the first switch of the electromagnetic switch module comprises a leaf spring and a power junction, the leaf spring is separated from the power junction so as to turn off the first switch when the linkage element is at the first position, and the leaf spring is contact with the power junction so as to turn on the first switch when the linkage element is at the second position.

5. The connector of claim 4, wherein the linkage element comprises:
a push element disposed adjacent to the leaf spring.

6. The connector of claim 2, wherein the linkage element is disposed on a top surface, a bottom surface or a side surface of the housing of the electronic device.

7. The connector of claim 1, wherein the sensing module comprises:
a solenoid coupled to the sensing element.

8. The connector of claim 1, wherein the sensing module comprises:
a second restoring element connected to the sensing element for elastically forcing the sensing element in a direction opposite to the movement of the sensing element by the electromagnetic force.

9. The connector device of claim 1, further comprising:
a capacitor electrically connected to the first switch.

10. The connector device of claim 9, further comprising:
a power supply for charging the capacitor;
a second switch electrically connecting the power supply and the capacitor; and
a switcher for turning off the second switch when the first switch is in an on position and turning on the second switch when the first switch is in an off position.

11. An electronic device, comprising:
a housing; and
a connector disposed in the housing to allow an external connection plug to be connected thereto, the connector comprising:
an electromagnetic switch module comprising a first switch to activate the electromagnetic switch module to produce an electromagnetic force; and
a sensing module comprising a sensing element and a connection port connected to the sensing element to allow the external connection plug to be connected thereto, wherein the sensing element is positioned to be moved by the electromagnetic force when the electromagnetic switch module is activated thereby separating the external connection plug from the connection port.

12. The electronic device of claim 11, wherein the connector comprises:
a linkage element passing through the housing and cooperating with the first switch of the electromagnetic switch module, wherein the linkage is operative to move between a first position and a second position, the first switch is turned off when the linkage element is at the first position, and the first switch is turned on when the linkage element is at the second position; and
a first restoring element connected to the linkage element for elastically forcing the linkage element toward the second position.

13. The electronic device of claim 12, further comprising a limiting frame, wherein the first restoring element is disposed between the limiting frame and the housing of the electronic device.

14. The electronic device of claim 12, wherein the first switch of the electromagnetic switch module comprises a leaf spring and a power junction, the leaf spring is separated from the power junction so as to turn off the first switch when the linkage element is at the first position, and the leaf spring is contact with the power junction so as to turn on the first switch when the linkage element is at the second position.

15. The electronic device of claim 14, wherein the linkage element comprises:
a push element disposed adjacent to the leaf spring.

16. The electronic device of claim 12, wherein the linkage element is disposed on a top surface, a bottom surface or a side surface of the housing of the electronic device.

17. The electronic device of claim 11, wherein the sensing module comprises:
a solenoid coupled to the sensing element.

18. The electronic device of claim 11, wherein the sensing module comprises:
a second restoring element connected to the sensing element for elastically forcing the sensing element in a direction opposite to the movement of the sensing element by the electromagnetic force.

19. The electronic device of claim 11, further comprising:
a capacitor electrically connected to the first switch.

20. The connector device of claim 19, further comprising:
a power supply for charging the capacitor;
a second switch electrically connecting the power supply and the capacitor; and
a switcher for turning off the second switch when the first switch is in an on position and turning on the second switch when the first switch is in an off position.
